(19) United States
(12) Patent Application Publication
(10) Pub. No.: US 2013/0141935 A1
(43) Pub. Date: Jun. 6, 2013

(54) LIGHT GUIDE PLATE AND BACKLIGHT MODULE

(71) Applicant: YUNG-LUN HUANG, Tu-Cheng (TW)

(72) Inventor: YUNG-LUN HUANG, Tu-Cheng (TW)

(73) Assignee: HON HAI PRECISION INDUSTRY CO., LTD., Tu-Cheng (TW)

(21) Appl. No.: 13/337,306

(22) Filed: Dec. 27, 2011

(30) Foreign Application Priority Data
Dec. 1, 2011 (TW) 100144180

(51) Int. Cl. G09F 13/04; F21V 5/04; F21V 13/04; F21V 7/00

(52) U.S. Cl. 362/602; 362/606; 362/608

(57) ABSTRACT

A backlight module includes a light guide plate, a light emergent portion, a Fresnel lens portion, and a number of light sources. The light incident portion includes an incident surface for receiving light rays, an emergent surface opposite to the incident surface having an area less than that of the incident surface; and a sloped surface connecting the emergent surface and positioned between the incident surface and the emergent surface. The light emergent portion extends from the light incident portion. The Fresnel lens portion is positioned on the sloped surface for directing the light rays projecting on the sloped surface to the light emergent portion. The light source arranged in front of the incident surface for emitting the light rays to the incident surface.

### BACKGROUND

1. Technical Field

The present disclosure relates to light guide plates and, particularly, to a light guide plate, which is efficient in use of light rays, and a backlight module using the light guide plate.

2. Description of Related Art

Backlight modules usually include a light source and a light guide plate. To reduce size while increasing the usage of light rays, a wedge light guide plate is employed. The wedge light guide plate includes a wedge portion and a flat portion extending from a narrow end of the wedge portion. A thick end surface of the wedge light guide plate, functions as a light incident surface to receive more light rays and thus increase usage of the light rays. The flat portion has a reduced size as compared to the thick end of the wedge portion is beneficial for reducing the total size of the light guide plate. However, a part of the light rays may leak out the light guide plate as the light guide plate diminishes along a propagating path of the light rays, decreasing the usage efficiency of light rays.

Therefore, it is desirable to provide a light guide plate and a backlight module which can overcome the limitations described.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic, side view of a backlight module according to a first embodiment of the present disclosure.

FIG. 2 is cross-section view of a Fresnel lens.

FIG. 3 is a top view of the Fresnel lens of FIG. 2.

FIG. 4 is top view of the backlight module of FIG. 1.

FIG. 5 is a schematic, side view of a backlight module according to a second embodiment of the present disclosure.

### DETAILED DESCRIPTION

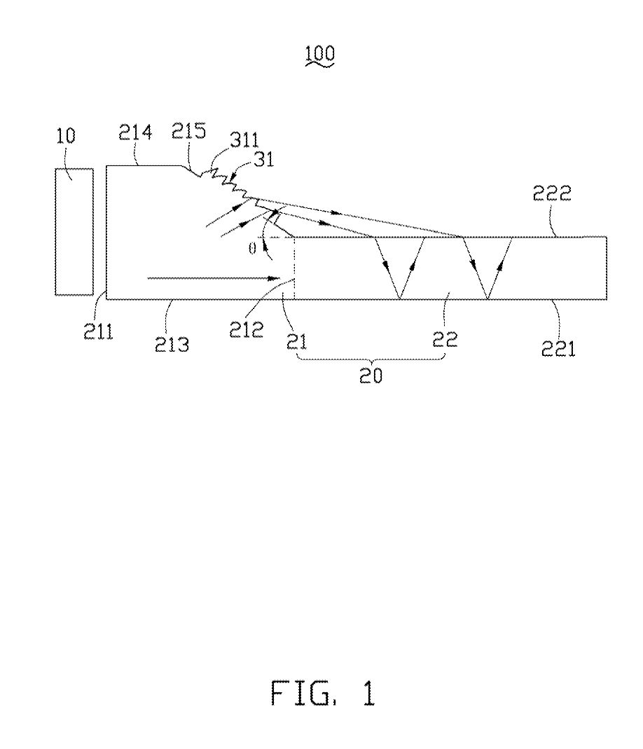

Referring to FIG. 1, a backlight module 100 according to a first embodiment is shown. The backlight module 100 includes a number of light sources 10 and a light guide plate 20.

The light sources 10 are positioned at one side of the light guide plate 20. In this embodiment, the light sources 10 are light emitting diode (LED) light sources. In other embodiments, the light sources 10 can be a light tube.

The light guide 20 is generally wedge-shaped and includes a light incident portion 21, a light emergent portion 22 connected to the light incident portion 21, and a Fresnel lens portion 31. The light incident portion 21, the light emergent portion 22, and the Fresnel lens portion 31 are integrally formed and made of plastic or glass. In alterative embodiments, the light incident portion 21, the light emergent portion 22, and the Fresnel lens portion 31 can be separately manufactured and connected together by adhesive or other methods.

The light incident portion 21 includes an incident surface 211, an emergent surface 212 opposite to the incident surface 211, a bottom surface 213 perpendicularly connecting the emergent surface 211 and the incident surface 212, a top surface 214 opposite to the bottom surface 213 and connecting the incident surface 211, and a sloped surface 215 connecting the top surface 214 and the emergent surface 212 and inclined about the incident surface 211. The light sources 10 are positioned in front of the incident surface 211 for emitting light rays to the incident surface 211. Each of the light sources 10 is substantially aligned with the top surface 214 and the bottom surface 213. The incident surface 211 receives light rays from the light sources 10 and directs the light rays into the light guide plate 20. The incident surface 211 and the emergent surface 212 are generally rectangular. The area of the emergent surface 212 is less than that of the incident surface 211. Each of the bottom surfaces 213, the top surface 214, and the sloped surface 215 is generally rectangular.

The light emergent portion 22 is generally a flat plate and perpendicularly extends from the emergent surface 212. The light emergent portion 22 includes a reflecting surface 221 perpendicular to the emergent surface 212 and an emitting surface 222 opposite to the reflecting surface 221. The reflecting surface 221 and the emitting surface 222 are generally rectangular. The reflecting surface 221 is coated with light reflective material such as polyethylene terephthalate (PET) and coplanar with the bottom surface 213. In alterative embodiments, the reflecting surface 221 and the bottom surface 213 are both coated with light reflective material. The emitting surface 222 connects to the sloped surface 215. A liquid crystal display (not shown) is positioned above the emitting surface 222 for receiving light rays from the emitting surface 222. An acute angle θ is formed between the sloped surface 215 and an extension of the emitting surface 222. The acute angle θ is in a range from about 30 degrees to 55 degrees. The thickness of the light emergent portion 22 (namely, the distance between the reflecting surface 221 and the emitting surface 222) is less than that of the light incident portion 21 (namely, the distance between the top surface 214 and the bottom surface 213). In one embodiment, the thickness of the light emergent portion 22 is about 0.4 millimeters and the thickness of the light incident portion 21 is about 0.6 millimeters.

The Fresnel lens portion 31 is positioned on the sloped surface 215.

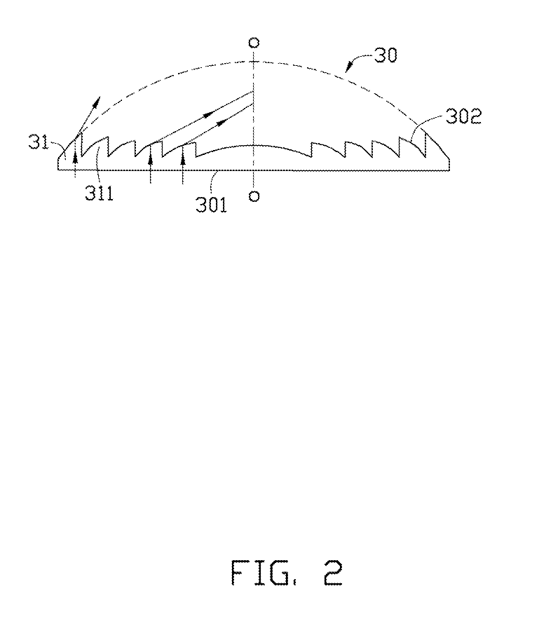

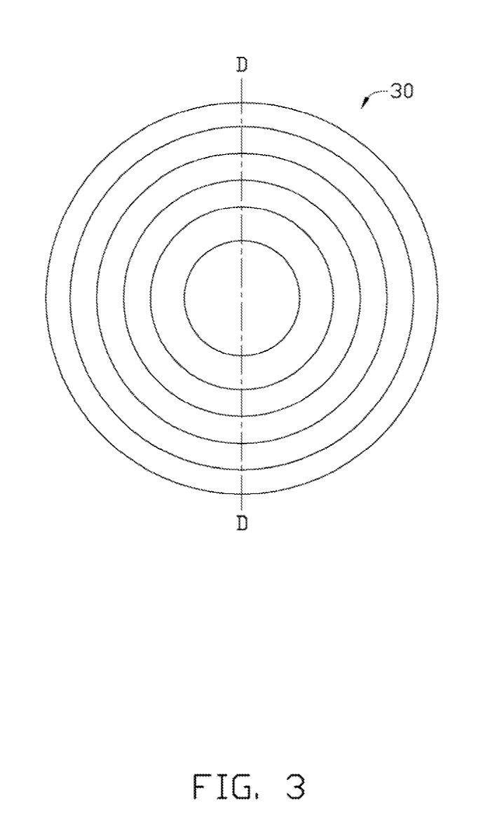

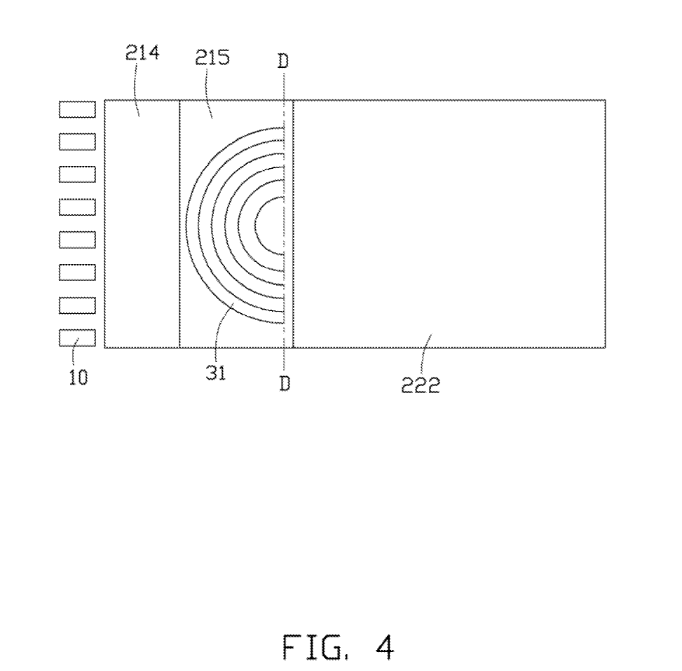

Referring to FIG. 2 to FIG. 4, showing a Fresnel lens 30. The Fresnel lens 30 is circular and has an optical axis OO. The Fresnel lens 30 includes a planar first surface 301 and a generally saw-teeth second surface 302. The first surface 301 directs light rays into the Fresnel lens 30. The light rays converge to the second surface 302 at the optical axis OO when the light rays emerge from the second surface 302. The Fresnel lens 30 includes a number of annular micro-lenses 311 which are coaxial with each other. In one embodiment, a pitch between two adjacent micro-lenses 311 can be in a range from about 50 micron meters (μm) to 80 μm. The Fresnel lens 30 is divided into two halves along a radial direction DD of the Fresnel lens 30 with a cut surface passing through the optical axis OO. The Fresnel lens portion 31 is one of the two halves of the Fresnel lens 30. In this embodiment, the Fresnel lens portion 31 is positioned on the sloped surface 215 with the first surface 301 in contact with the sloped surface 215. The optical axis OO is adjacent to a line of an intersection between the sloped surface 215 and the emitting surface 222 (namely, adjacent to the emitting surface 222). The cut surface is substantially parallel to the line of the intersection between the sloped surface 215 and the emitting surface 222.

Referring to FIG. 1, in use, the incident surface 211 receives light rays from the light sources 10 and directs the light rays into the light guide plate 20. A part of the light rays of the light sources 10 projects on the sloped surface 215. Because the sloped surface 215 is inclined about the incident surface 211, an incident angle of each light ray projecting on the sloped surface 215 is usually less than a total reflection angle such that the light rays projecting on the sloped surface 215 usually cannot be totally reflected to the light emergent portion 22 and may be refracted out the sloped surface 215 as such may not be utilized by the light emergent portion 22. However, the Fresnel lens portion 31 positioned on the sloped surface 215 can converge this part of light rays projecting on the sloped surface 215 toward the emitting surface 222 (namely, toward the optical axis OO). Then this part of light rays projecting on the sloped surface 215 are refracted into the light emergent portion 22 when projected on the emitting surface 222 and then project on the reflecting surface 221 and finally projected to the liquid crystal display. Therefore, the usage efficiency of the light rays of the light source 10 can be increased by the Fresnel lens portion 31. According simulated experiments, the usage efficiency of the light rays of the light sources 10 can be increased by about 5% to 10% relative to the light guide plate 20 not positioned with the Fresnel lens portion 31. Furthermore, the usage efficiency of the light rays of the light sources 10 can be increased by about 10% when the acute angle θ is about 55 degrees.

In alterative embodiments, the light guide plate 20 can include more than one Fresnel lens portion 31 positioned on the sloped surface 215 and arranged in a matrix.

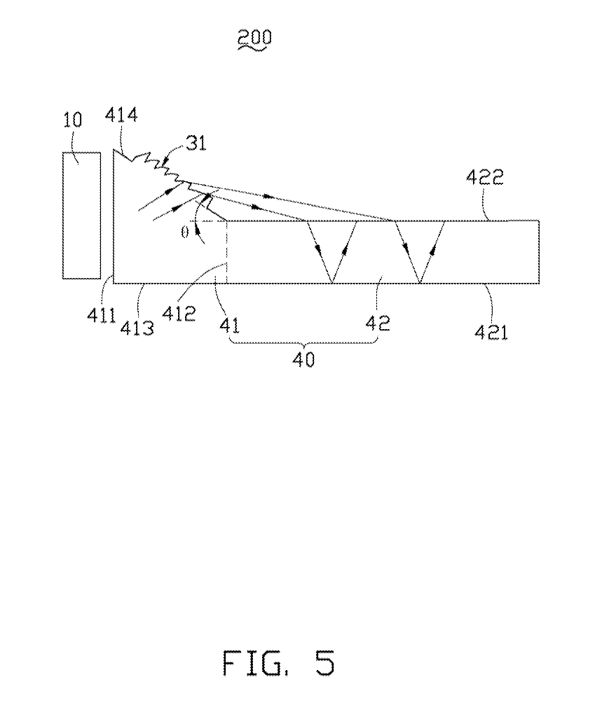

Referring to FIG. 5, a backlight module 200 according to a second embodiment is shown. The backlight module 200 includes a generally wedge-shaped light guide plate 40 and a number of light sources 10 positioned at one side of the light guide plate 40. The light guide plate 40 includes a light incident portion 41, a light emergent portion 42, and a Fresnel lens portion 31.

The light incident portion 41 includes an incident surface 411, an emergent surface 412 opposite to the incident surface 411, a bottom surface 413 perpendicularly connecting the incident surface 411 and emergent surface 412, and a sloped surface 414 connecting the incident surface 411 and the emergent surface 412. The light emergent portion 42 perpendicularly extends from the emergent surface 412. The light emergent portion 42 includes a reflecting surface 421 perpendicular to the emergent surface 412 and an emitting surface 422 opposite to the reflecting surface 421. The reflecting surface 421 is coated with light reflective material and coplanar with the bottom surface 413. The emitting surface 422 connects to the sloped surface 414. An acute angle θ is formed between the sloped surface 414 and an extension of the emitting surface 422. The acute angle θ is in a range from about 30 degrees to 55 degrees. The Fresnel lens portion 31 is positioned on the sloped surface 414.

The backlight module 200 of the second embodiment is similar to the backlight module 100 of the first embodiment, except that, the light guide plate 40 of second embodiment does not include the top surface 214. Therefore, the light guide plate 40 can be further miniaturized relative to the light guide plate 20 of the first embodiment.

It will be understood that the above particular embodiments are shown and described by way of illustration only. The principles and the features of the present disclosure may be employed in various and numerous embodiments thereof without departing from the scope of the disclosure. The above-described embodiments illustrate the scope of the disclosure but do not restrict the scope of the disclosure.

What is claimed is:

1. A light guide plate, comprising:
a light incident portion comprising:
an incident surface for receiving light rays;
an emergent surface opposite to the incident surface and having an area less than that of the incident surface; and
a sloped surface connecting the emergent surface and positioned between the incident surface and the emergent surface;
a light emergent portion extending from the emergent surface; and
a Fresnel lens portion positioned on the sloped surface for directing the light rays projecting on the sloped surface to the light emergent portion.

2. The light guide plate of claim 1, wherein the Fresnel lens portion is a half of a circular and entire Fresnel lens and comprises a planar first surface, a saw-teeth second surface opposite to the first surface, and a cut surface through which an optical axis of the Fresnel lens passes, and the Fresnel lens portion is positioned on the sloped surface with the first surface in contact with the sloped surface.

3. The light guide plate of claim 2, wherein the light emergent portion comprises a reflecting surface substantially perpendicular to the emergent surface and an emitting surface opposite to the reflecting surface, the optical axis is adjacent to a line of an intersection between the sloped surface and the emitting surface, the cut surface is substantially parallel to the line of the intersection between the sloped surface and the emitting surface.

4. The light guide plate of claim 3, wherein the Fresnel lens comprises a number of annular micro-lenses coaxial with each other, a pitch between two adjacent micro-lenses is in a range from about 50 micro meters to 80 micro meters.

5. The light guide plate of claim 3, wherein an acute angle is formed between the sloped surface and an extension of the emitting surface and in a range from about 30 degrees to about 55 degrees.

6. The light guide plate of claim 3, wherein the light incident portion further comprises a top surface and a bottom surface, the top surface directly connects the incident surface and the sloped surface, the bottom surface perpendicularly connects the incident surface and the emergent surface, and the bottom surface is coplanar with the reflecting surface.

7. The light guide plate of claim 1, wherein the light incident portion, the light emergent portion, and the Fresnel lens portion are integrally formed with each other.

8. The light guide plate of claim 1, wherein the sloped surface directly connects the incident surface and the emergent surface.

9. A backlight module comprising:
a light guide plate comprising:
a light incident portion comprising:
an incident surface for receiving light rays;
an emergent surface opposite to the incident surface having an area less than that of the incident surface; and
a sloped surface connecting the emergent surface and positioned between the incident surface and the emergent surface;
a light emergent portion extending from the emergent surface; and
a Fresnel lens portion positioned on the sloped surface for directing the light rays projecting on the sloped surface to the light emergent portion; and
a number of light sources arranged in front of the incident surface for emitting the light rays to the incident surface.

10. The backlight module of claim 9, wherein the Fresnel lens portion is a half of a circular and entire Fresnel lens and comprises a planar first surface, a saw-teeth second surface opposite to the first surface, and a cut surface through which an optical axis of the Fresnel lens passes, and the Fresnel lens portion is positioned on the sloped surface with the first surface in contact with the sloped surface.

11. The backlight module of claim 9, wherein the light incident portion further comprises a top surface and a bottom surface, the top surface directly connects the incident surface and the sloped surface, the bottom surface connects the incident surface and the emergent surface, and the bottom surface is coplanar with the reflecting surface.

12. The backlight module of claim 9, wherein the sloped surface directly connects the incident surface and the emergent surface.

13. The backlight module of claim 9, wherein a thickness of the light incident portion is about 0.6 millimeters, a thickness of the light emergent portion is about 0.4 millimeters.
